(19) United States
(12) Patent Application Publication
(10) Pub. No.: US 2007/0051195 A1
(43) Pub. Date: Mar. 8, 2007

(54) Spindle nut

(76) Inventor: Michael Hoermann, Halle/Westf. (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/510,502

(22) Filed: Aug. 24, 2006

(30) Foreign Application Priority Data
Aug. 26, 2005 (DE) 20 2005 013 514.3

(51) Int. Cl. F16H 27/02

(52) U.S. Cl. 74/89.23; 29/447

(57) ABSTRACT

The present disclosure relates to a spindle nut which, as part of a drive device, is connected to a tube, wherein the spindle nut has a substantially cylindrical shoulder in which at least two recesses are cut out, wherein a tube is pushed over the cylindrical shoulder of the spindle nut and wherein the tube is deformed toward the recess in the region of the recesses such that the deformed regions contact the walls of the recess.

### CROSS-REFERENCE TO RELATED APPLICATION

This application claims priority to German Utility Model Application Serial No. 20 2005 013 514.3 filed Aug. 26, 2005, which is hereby incorporated by reference in its entirety for all purposes.

### FIELD

The present disclosure relates to a spindle nut which, as part of a drive device, is connected to a tube.

### BACKGROUND AND SUMMARY

Spindle drives are common in different sectors of drive engineering. In the manufacture of such spindle drives, the spindle nut has to be connected, as an inwardly disposed part, to a tube. Different connection techniques have previously been used for this purpose. The spindle nut has thus, for example, been screwed in via a corresponding internal thread which is provided in the tube. Alternatively, the spindle nut forming the inwardly disposed part and the tube are connected to one another by a pin. Another connection technique consists of beads being applied in the tube.

In this connection by the application of beads or by the so-called pinning, that is in the plug connection between tube and inner part, no very high forces can be transferred. The screw connection of the tube is, in contrast, very costly since both the spindle nut and the tube each have to be provided with a thread.

It is therefore the object of the present disclosure to provide a spindle nut which can be connected, as part of a drive device, in a simple and cost-effective manner to a tube.

The object is solved in accordance with the present disclosure by a spindle nut that has a substantially cylindrical shoulder in which at least two recesses are cut out. A tube is pushed over the cylindrical shoulder of the spindle nut. In the region of the tube disposed above the recesses, the tube is now deformed toward the recess that the deformed regions of the tube contact the wall of the recess. A shape-matched connection is hereby provided between the spindle nut as an inwardly disposed part and the corresponding tube. The tube present as a single part can hereby be connected to the spindle nut present as a single part in one workstep without any further additional parts in a cost-effective manner.

Preferred aspects of the present disclosure result from the dependent claims following on from the main claim. Accordingly, first deformed regions of the tube can be supported particularly advantageously at the mutually oppositely disposed walls of a recess in the cylindrical shoulder of the spindle nut which extend parallel to the longitudinal axis of the tube. At the same time, second deformed regions of the tube can be supported at the mutually oppositely disposed walls of a recess which extend transversely to the longitudinal axis of the tube. The force of a spindle rotating in the spindle nut can hereby be transmitted in the radial direction and in the axial direction.

The deformation of the tube for the connection to the spindle nut can be formed in a simple manner by press-fitting.

The spindle nut in accordance with the present disclosure is advantageously provided as part of a rotary tube drive. Alternatively, it can also be provided as part of a shutter drive. A use in such drives is therefore possible since here a reliable transmission of force in the radial or axial direction is made possible.

### BRIEF DESCRIPTION OF THE FIGURES

Further features, details and advantages of the present disclosure result from the embodiment variant shown in the drawing. There are shown:

FIG. 1 is a perspective representation drawn apart in an exploded manner of the spindle nut with tube;

FIG. 2 shows three different side views of the tube in accordance with FIG. 1; and

FIG. 3 shows three views and a section through the spindle nut in accordance with FIG. 1.

### DETAILED DESCRIPTION

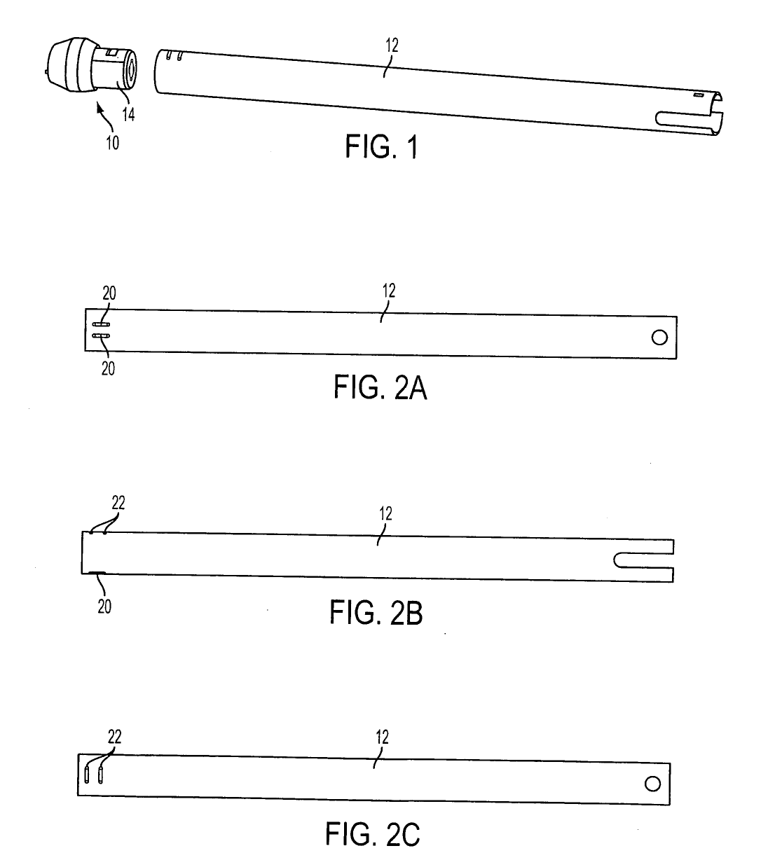

A spindle nut 10 and a tube 12 are shown in FIG. 1, with the spindle nut 10 and the tube 12 here being drawn apart in an exploded manner. In the assembled state, the tube 12 is applied to a cylindrical shoulder 14 of the spindle nut 10. The spindle nut 10 shown here and the tube 12 form, in the embodiment, a part of a rotary tube drive in which the tube 12 is realized as a piston rod.

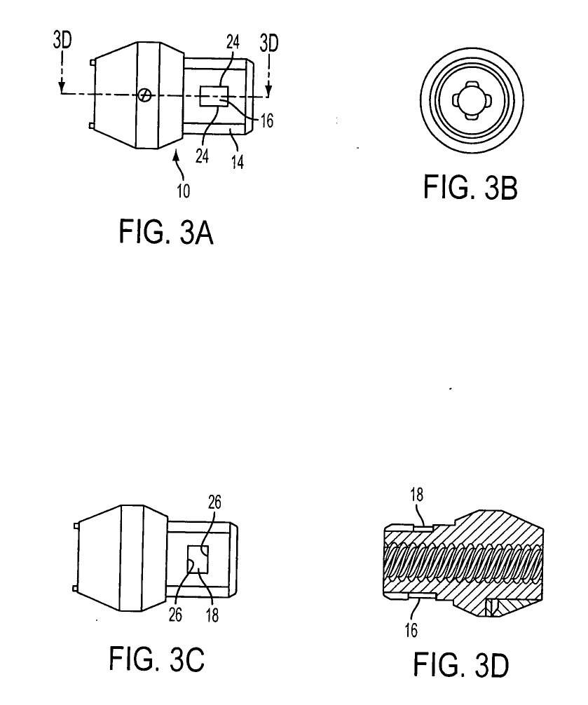

The more exact structure results from FIGS. 2 and 3. The spindle nut 10 with its cylindrical shoulder 14 has two rectangular recesses 16 and 18 in the region of the cylindrical shoulder 14 which, as can be seen from FIG. 3, are arranged mutually oppositely disposed. The tube 12 or the piston rod 12 is press-fit in the region of the part disposed above the recesses 16 or 18 after it has been pushed onto the cylindrical shoulder 14 so that the respectively oppositely disposed region of the tube is supported against the walls of the recess 16 or 18. As shown with reference to FIG. 2, slots 20 and 22 are already provided in the region of the tube 12 which should be deformed, that is press-fit. In the slots 20 disposed opposite the recess 16, the deformed part of the tube will, after corresponding press-fitting, be supported against the walls 24 extending parallel to the longitudinal axis of the tube. In contrast, the region of the tube between the slots 22 disposed opposite the recess 18 will be supported at the walls 26 of the recess 18 which extend transversely to the longitudinal axis of the tube. A radial and axial securing of the tube 12 or of the piston rod 12 with the spindle nut 10 is hereby achieved. This securing transmits the force of the spindle—not shown in any more detail here—rotating in the spindle nut 10 in the radial or axial direction.

1. A spindle nut, as part of a drive device, comprising:
a substantially cylindrical shoulder in which at least two recesses are cut out; and
a tube pushed over the cylindrical shoulder of the spindle nut, where the tube is deformed toward the recess in a region of the recesses and the deformed regions contact walls of the recess.

2. The spindle nut in accordance with claim 1, wherein first deformed regions of the tube are supported at mutually oppositely disposed walls of one of said recesses which extend parallel to a longitudinal axis of the tube; and second deformed regions of the tube are supported at the mutually oppositely disposed walls of said recess which extend transversely to the longitudinal axis of the tube.

3. The spindle nut in accordance with claim 1, wherein the deformation of the tube is formed by press-fitting.

4. The spindle nut in accordance with claim 1, wherein the nut further comprises a shape-matched connection between the spindle nut as an inwardly disposed part and the tube.

5. The spindle nut in accordance with claim 1, wherein the drive device is a shutter drive device.

6. A system comprising:
a rotary tube drive device; and
a spindle nut connected to a tube of said rotary tube drive device, the spindle nut having a substantially cylindrical shoulder in which at least two recesses are cut out, said tube pushed over the cylindrical shoulder of the spindle nut, where the tube is deformed toward the recess in a region of the recesses and the deformed regions contact walls of the recess.

7. The system in accordance with claim 6, wherein first deformed regions of the tube are supported at mutually oppositely disposed walls of one of said recesses which extend parallel to a longitudinal axis of the tube; and second deformed regions of the tube are supported at the mutually oppositely disposed walls of said recess which extend transversely to the longitudinal axis of the tube.

8. The system in accordance with claim 7, wherein the deformation of the tube is formed by press-fitting.

9. A method of forming a drive device, comprising:
connecting a tube to a spindle nut in one workstep without any further additional parts, said spindle nut having a substantially cylindrical shoulder in which at least two recesses are cut out, by pushing the tube over the cylindrical shoulder of the spindle nut, where the tube is deformed toward the recess in a region of the recesses and the deformed regions contact walls of the recess.

10. The method in accordance with claim 9, wherein the drive device is a shutter drive device.

11. The method in accordance with claim 9, wherein the drive device is a rotary tube drive device.

12. The method in accordance with claim 9, wherein the deformation of the tube is formed by press-fitting.
